(19) United States
(12) Patent Application Publication
(10) Pub. No.: US 2014/0006646 A1
(43) Pub. Date: Jan. 2, 2014

(54) Semiconductor Device Using Serial ATA Protocol and System Including the Same

(71) Applicant: SAMSUNG ELECTRONICS CO., LTD., Suwon-si (KR)

(72) Inventors: Young-Jin Cho, Seoul (KR); Ho-Ha Kim, Hwaseong-si (KR)

(73) Assignee: SAMSUNG ELECTRONICS CO., LTD., Suwon-si (KR)

(21) Appl. No.: 13/791,153

(22) Filed: Mar. 8, 2013

(30) Foreign Application Priority Data
Jun. 27, 2012 (KR) 10-2012-0069254

(51) Int. Cl. G06F 13/12

(52) U.S. Cl. CPC G06F 13/126
USPC 710/5

(57) ABSTRACT

A semiconductor device includes a delay unit determining a delay value. A FIS (Frame Information Structure) receiver is connected to a transfer channel and receives a first H2D (Host to Device) FIS including first command information. A FIS generator is connected to a receiving channel and successively outputs a first DMA (Direct Memory Access) setup FIS, a first data FIS, and a first SDB (Set Device Bits) FIS after outputting a first D2H (Device to Host) FIS in response to the first H2D FIS, and to insert a delay period as large as the delay value next to the first data FIS or the first SDB FIS.

### CROSS-REFERENCE TO RELATED APPLICATIONS

This application is based on and claims priority from Korean Patent Application No. 10-2012-0069254, filed on Jun. 27, 2012 in the Korean Intellectual Property Office, the disclosure of which is incorporated herein in its entirety by reference.

### TECHNICAL FIELD

The present invention relates to a semiconductor device, and more particularly to a semiconductor device that uses a serial ATA protocol and a system including the same.

### DISCUSSION OF THE RELATED ART

A serial ATA (Serial Advanced Technology Attachment) protocol is a data transfer method that is nearly twice as fast as a PATA (Parallel Advanced Technology Attachment) protocol. SATA utilizes an external connection cable that is conveniently configured to facilitate connection and assembly.

### SUMMARY

When a master device and a slave device communicate with each other using a serial ATA protocol, the slave has priority over the master in transferring data. For example, when the master and the slave simultaneously start a transaction, a command sent by the master is disregarded and the slave transfers data to the master. Accordingly, while the slave starts to successively transfer multiple units of data, the master is unable to transfer a command to the slave.

Accordingly, exemplary embodiments of the present invention provide a semiconductor device that receives a command from a host even when a slave starts to successively transfer multiple units of data.

Exemplary embodiments of the present invention provide a system in which a host provides a command to a slave even when the slave starts to successively transfer multiple units of data.

Additional aspects and features of exemplary embodiments of the present invention will be set forth in the description which follows.

According to an aspect of the present invention, there is provided a semiconductor device including a delay unit determining a delay value. A FIS (Frame Information Structure) receiver is connected to a transfer channel and receives a first H2D (Host to Device) FIS including first command information. A FIS generator is connected to a receiving channel and successively outputs a first DMA (Direct Memory Access) setup FIS, a first data FIS, and a first SDB (Set Device Bits) FIS after outputting a first D2H (Device to Host) FIS in response to the first H2D FIS. A delay period as large as the delay value next to the first data FIS or the first SDB FIS is inserted.

According to an aspect of the present invention, there is provided a semiconductor device including a FIS receiver successively receive first to n-th (where, n is a natural number that is equal to or larger than “2”) H2D FIS that include first to n-th command information, respectively. A FIS generator successively outputs first to m-th (where, m is a natural number that is equal to or larger than “2”) FIS related to the first to n-th command information after successively outputting first to n-th D2H FIS in response to the first to n-th H2D FIS. While the FIS generator outputs only parts of the first to m-th FIS, the FIS receiver receives the (n+1)-th H2D FIS, and the FIS generator outputs the (n+1)-th D2H FIS in response the (n+1)-th H2D FIS, between a k-th (where, k is a natural number that satisfies 1<k<m) FIS and a (k+1)-th FIS.

### BRIEF DESCRIPTION OF THE DRAWINGS

The above and other objects, features and aspects of the present invention will be more apparent from the following detailed description taken in conjunction with the accompanying drawings, in which:

FIG. 1 is a block diagram illustrating a system according to some exemplary embodiments of the present invention;

FIG. 2 is a block diagram illustrating the slave (e.g., semiconductor) device illustrated in FIG. 1;

FIG. 3 is a block diagram illustrating an interface illustrated in FIG. 2;

FIGS. 4 and 5 are timing diagrams illustrating the operation of the interface illustrated in FIG. 2;

FIG. 6 is a timing diagram illustrating an operation of the interface illustrated in FIG. 2;

FIG. 7 is a block diagram illustrating the semiconductor device according to an exemplary embodiment of the present invention;

FIG. 8 is a block diagram illustrating a delay unit illustrated in FIG. 7;

FIG. 9 is a timing diagram illustrating the operation of the interface illustrated in FIGS. 7 and 8; and

FIG. 10 is a timing diagram illustrating an operation of the interface illustrated in FIGS. 7 and 8.

### DETAILED DESCRIPTION OF THE EXEMPLARY EMBODIMENTS

Aspects and features of exemplary embodiments of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. In the drawings, the thickness of layers and regions may be exaggerated for clarity.

It will be understood that when an element or layer is referred to as being “on” or “connected to” another element or layer, it can be directly on or connected to the other element or layer or intervening elements or layers may be present. Like numbers may refer to like elements throughout.

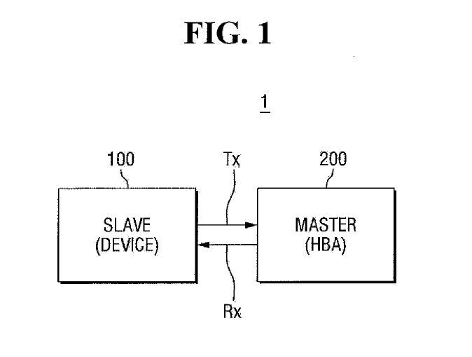

FIG. 1 is a block diagram illustrating a system according to some exemplary embodiments of the present invention.

Referring to FIG. 1, a system 1 according to some exemplary embodiments of the present invention may include a slave device 100 and a master device 200. Here, the slave device 100 and the master device 200 may be any devices that can communicate with each other using a serial ATA protocol. The master device 200 may be a HBA (Host Bus Adapter) and the slave device 100 may be any device.

The slave device 100 is connected to the master device 200 through a transfer channel Tx and a receiving channel Rx.

In the serial ATA protocol, the master device 200 and the slave device 100 transfer and receive data or a command in a FIS (Frame Information Structure) form. Here, the FIS may include primitives, such as SOF, transport layer information, CRC, and/or EOF. The SOF is a Start Of Frame, and the transport layer information is a data/command that is actually transmitted. The CRC is a Cyclic Redundancy Check frame for verification and EOF is End Of Frame.

The serial ATA protocol operates as a half duplex at a FIS level and operates as a full duplex at a primitive level. For example, when the master device 200 and the slave device 100 communicate with each other using the serial ATA protocol, the slave device 100 has priority over the master device 200 in transferring data. For example, when the master device 200 and the slave device 100 simultaneously start transactions, a FIS including a command that the master device 200 sends through a receiving channel Rx is disregarded and the slave device 100 can transfer a FIS including data to the master device 200 through a transfer channel Tx.

The serial ATA protocol may include several control modes. For example, the serial ATA protocol may include a PATA (IDE) mode, a RAID (Redundant Array of Independent Disk) mode, an AHCI (Advanced Host Controller Interface) mode, and the like. Particularly, in the case of the AHCI mode, NCQ (Native Command Queuing) is supported. For example, the slave device 100 may successively receive multiple FIS including multiple commands from the master device 200 and then make the commands in a queuing state (for example, queued commands). The slave device 100 may successively output the multiple FIS including the multiple units of data according to the queued commands.

In the system 1 according to some exemplary embodiments of the present invention, the slave device 100 may transfer multiple FIS to the master device 200 while inserting a delay period between the multiple FIS. Accordingly, during the inserted delay period, the master device 200 can transfer the FIS including the commands to the slave device 100. If no delay period is inserted, for example, if 30 commands are in the queuing state, the master device 200 is unable to transfer the FIS including the commands until the slave device 100 processes 30 commands completely.

Hereinafter, insertion of the delay period performed by the slave device 100 will be described in detail.

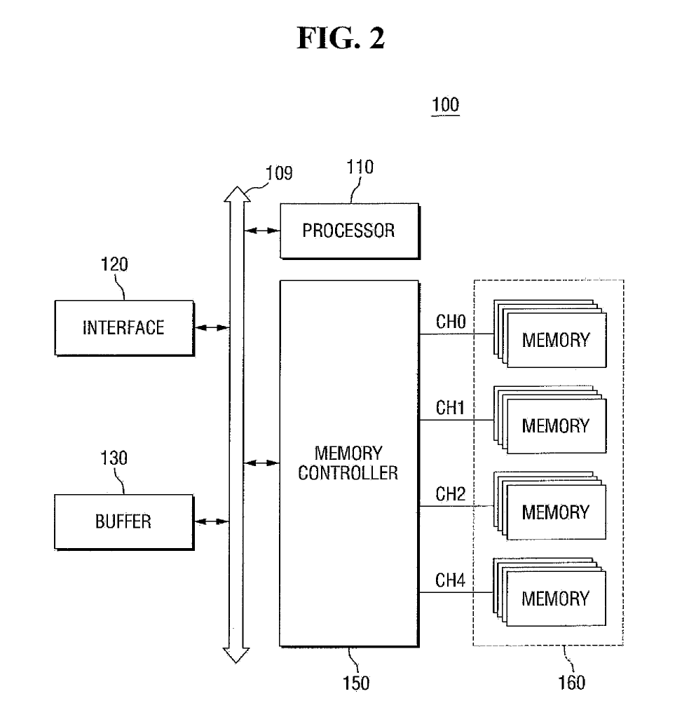

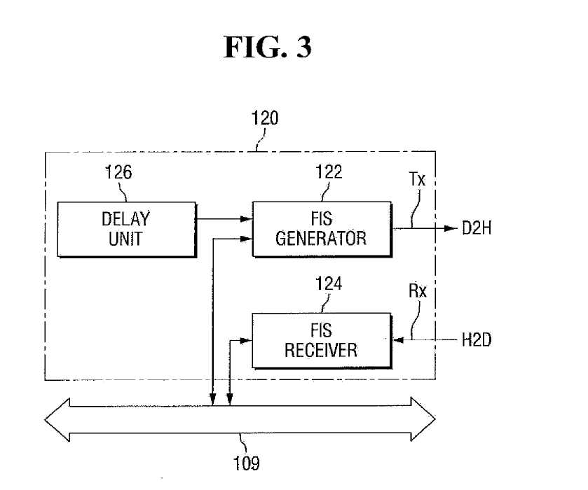

FIG. 2 is a block diagram illustrating a slave device (for example, a semiconductor device) illustrated in FIG. 1. FIG. 3 is a block diagram illustrating an interface illustrated in FIG. 2. FIG. 2 illustrates an exemplary SSD (Solid Static Disk). However, the slave device 100 is not limited thereto but may be a HDD (Hard Disk Drive) or a hybrid disk that combines SSD with HDD.

Referring to FIGS. 2 and 3, the slave device 100 may include a processor 110, an interface 120, a buffer 130, a memory controller 150, and multiple memories 160.

The interface 120 communicates with the master device 200 (in FIG. 1) using the serial ATA protocol under the control of the processor 110. The interface 120 patches commands, data, and addresses from the master device 200 and transfers the patched commands, data and addresses to the processor 110 through a bus 109.

Further, the interface 120 may transfer multiple FIS while inserting a delay period between the multiple FIS. The interface 120 may include a delay unit 126, an FIS receiver 124 and an FIS generator 122.

The delay unit 126 determines the delay value. Here, the delay value may be a fixed value. For example, the delay value may be a value determined at a power-up time point of the semiconductor device, but is not limited thereto.

The FIS receiver 124 is connected to the receiving channel Rx, and receives a H2D FIS including command information. Here, H2D may mean “Host to Device”.

The FIS generator 122 is connected to the transfer channel Tx and outputs a D2H FIS in response to the H2D FIS. Here, D2H may mean “Device to Host”. For example, in the case of the D2H, a DMA (Direct Memory Access) setup FIS corresponding to command information, a data FIS, and an SDB (Set Device Bits) FIS are successively output, and a delay period as large as the delay value may be inserted next to the data FIS or SDB FIS. The DMA setup FIS may be an FIS that is sent in advance before actual data is sent. The data FIS may be an FIS that includes actual data, and the SDB FIS is an FIS indicating that the data has been sent normally.

Specifically, it is assumed that several H2D FIS are successively input.

The FIS receiver 124 successively receives the first to n-th H2D FID (where, n is an integer that is equal to or larger than “2”) and the first to n-th H2D FIS include the first to n-th command information.

The FIS generator 122 successively outputs the first to n-th D2H FIS in response to the first to n-th H2D FIS and then successively outputs the first to m-th (where, m is a natural number that is equal to or larger than “2”) FIS that are related to the first to n-th command information. Here, m may be 3 n. As described above, in order to transmit data, three FIS, for example, the DMA setup FIS, the data FIS, and the SDB FIS, are necessary. However, if the product or protocol, which has been used, is changed, this requirement may be changed. For example, m may be a number that is not 3 n. While the FIS generator 122 outputs only parts of the first to m-th FIS, the FIS receiver 124 may receive the (n+1)-th H2D FIS and the FIS generator 122 may output the (n+1)-th D2H FIS in response to the (n+1)-th H2D FIS, between the k-th (where, k is a natural number that satisfies 1<k<m) FIS and the (k+1)-th FIS. The FIS generator 122 can insert the delay period as large as the delay value between the k-th FIS and the (k+1)-th FIS and output the (n+1)-th D2H FIS during the delay period.

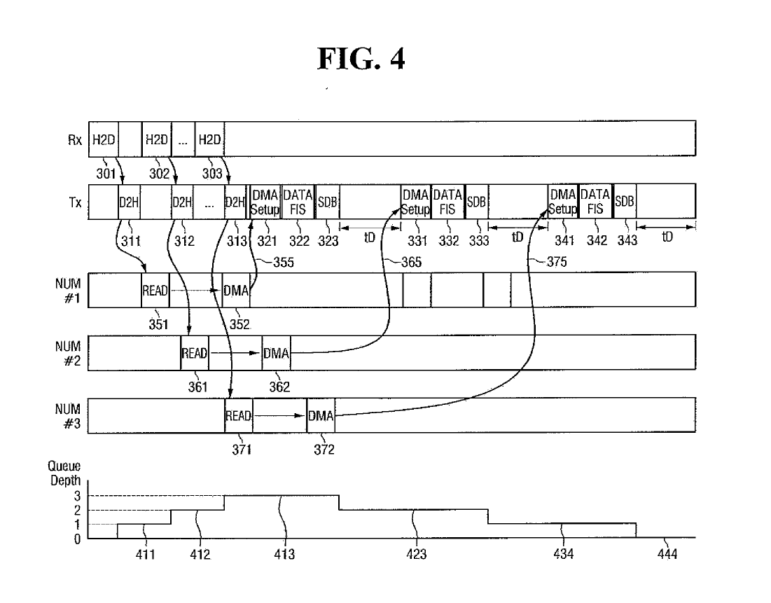

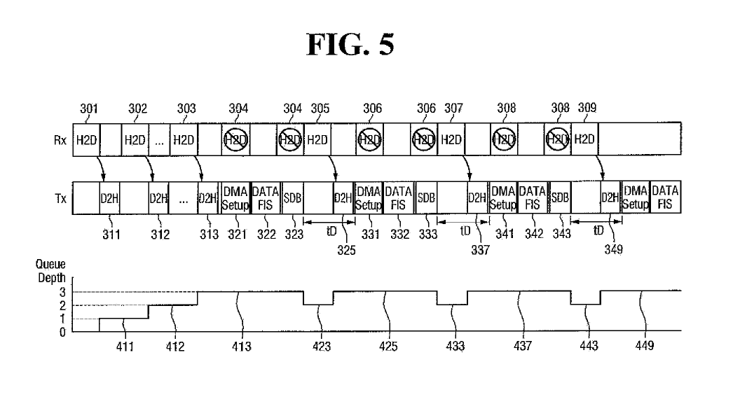

The operation of the interface 120, as described above, will be described below with reference to FIGS. 4 and 5.

Referring again to FIG. 2, the buffer 130 may temporarily store data that is transmitted between the master device 200 and the slave device 100. For example, the data that is read from the multiple memories 160 may temporarily be stored in the buffer 130. In the buffer 130, programs to be operated by the processor 110 may be stored. The buffer 130 may be implemented by, for example, an SRAM.

The memory controller 150 may send and receive data with the memory 160. The memory controller 150 may be configured to support a NAND flash memory, a one-NAND flash memory, a multi-level flash memory, and/or a single-level flash memory. The processor 110 and the memory controller 150 may be implemented within a single ARM processor.

The memory controller 150 may be connected to the multiple memories 150 through multiple channels CH0 to CH4.

FIGS. 4 and 5 are timing diagrams illustrating the operation of the interface illustrated in FIG. 2.

First, referring to FIG. 4, the interface 120 successively receives the first H2D FIS 301, the second H2D FIS 302, and the third H2D FIS 303 through the receiving channel Rx. The first H2D FIS 301, the second H2D FIS 302, and the third H2D FIS 303 may include the first command information, the second command information, and the third command information, respectively. For example, each of the respective command information may be a command to read data that corresponds to the address of a specified memory 160.

Further, the interface 120 outputs the first D2H FIS 311 in response to the first H2D FIS 301, outputs the second D2H FIS 312 in response to the second H2D FIS 302, and outputs the third D2H FIS 313 in response to the third H2D FIS 303, through the transfer channel Tx. The respective D2H FIS 311, 312, and 313 indicate that the corresponding H2D FIS 301, 302, and 303 have been received.

Here, the first command information, the second command information, and the third command information are queued. For example, the first command information, the second command information, and the third command information become commands in a queuing state. As shown as the reference numerals 411, 412, and 413, it can be recognized that a queue depth is increased one by one as the queued command is information is increased one by one.

The memory NUM #1 reads first data in a read period 351 according to the first command information included in the first H2D FIS 301. In the DMA period 352, the memory NUM #1 moves and stores the first data being read in the buffer (see 130 in FIG. 2).

Then, if the first data is stored in the buffer 130, the first data is transferred to the master device 200 through the transfer channel Tx (see reference numeral 355). Specifically, in the serial ATA protocol, the interface 120 transfers the first data by outputting the first DMA setup FIS 321, the first data FIS 322, and the first SDB FIS 323. For example, the first command information is performed. Accordingly, the queue depth is decreased by “1” and becomes “2” (see 423).

The memory NUM #2 read second data in a read period 361 according to the second command information included in the second H2D FIS 302. In the DMA period 362, the memory NUM #2 moves and stores the second data being read in the buffer 130.

Then, if the second data is stored in the buffer 130, the second data is transferred to the master device 200 through the transfer channel Tx (see reference numeral 365). Specifically, in the serial ATA protocol, the interface 120 transfers the second data by outputting the second DMA setup FIS 331, the second data FIS 332, and the second SDB FIS 333. For example, the second command information is performed. Accordingly, the queue depth is decreased by “1” and becomes “1” (see 434).

The memory NUM #3 read third data in a read period 371 according to the third command information included in the third H2D FIS 303. In the DMA period 372, the memory NUM #3 moves and stores the third data being read in the buffer 130.

Then, if the third data is stored in the buffer 130, the third data is transferred to the master device 200 through the transfer channel Tx (see reference numeral 375). Specifically, in the serial ATA protocol, the interface 120 transfers the third data by outputting the third DMA setup FIS 341, the third data FIS 342, and the third SDB FIS 343. For example, the third command information is performed. Accordingly, the queue depth is decreased by “1” and becomes “0” (see 444).

As illustrated, an intentional delay period tD may be inserted next to the first SDB FIS 323 (for example, between the first SDB FIS 323 and the second DMA setup FIS 331) and next to the second SDB FIS 333 (for example, between the second SDB FIS 333 and the third DMA setup FIS 341).

Here, referring to FIG. 5, if the intentional delay period tD is inserted into a data transfer period, the master device 200 can transfer a command (for example, 112D FIS including the command) to the slave device 100 during the inserted delay period tD.

Specifically, the interface 120 successively receives the first H2D FIS 301, the second H2D FIS 302, and the third H2D FIS 303 through the receiving channel Rx.

Further, the interface 120 outputs the first D2H FIS 311 in response to the first H2D FIS 301, outputs the second D2H FIS 312 in response to the second H2D FIS 302, and outputs the third D2H FIS 313 in response to the third H2D FIS 303, through the transfer channel Tx. The first command information, the second command information, and the third command information become queued commands (see reference numerals 411, 412, and 413).

According to the first command included in the first H2D FIS 301, the interface 120 outputs the first DMA setup FIS 321, the first data FIS 322, and the first SDB FIS 323. For example, the first command information is performed. Accordingly, the queue depth is decreased by “1”, and becomes “2” (see reference numeral 423).

As described above, if the master device 200 transfers the fourth DMA setup FIS 304 through the receiving channel Rx while the slave device 100 transfers the first DMA setup FIS 321, the first data FIS 322, and the first SDB FIS 323 through the transfer channel Tx, the transfer of the fourth DMA setup FIS 304 through the master device 200 is disregarded. However, during the delay period tD next to the first SDB FIS 323, the interface 120 may receive the fifth H2D FIS 305 including the fifth command information. As a result, the interface 120 outputs the fifth D2H FIS 325 in response to the fifth H2D FIS 305. The fifth command information is queued. For example, the fifth command information becomes the queued command. Accordingly, the queued commands become the second command information, the third command information, and the fifth command information. Accordingly, the queue depth is increased by “1”, and becomes again “3” (see reference numeral 425).

According to the second command included in the second H2D FIS 302, the second DMA setup FIS 331, the second data FIS 332, and the second SDB FIS 333 are output. For example, the second command information is performed. Accordingly, the queue depth is decreased by “1”, and becomes “2” (see reference numeral 433).

Similarly, the interface 120 disregards the sixth H2D FIS 306 and receives the seventh H2D FIS 307 that includes the seventh command information during the delay period tD next to the second SDB FIS 333. Since the second data corresponding to the second command information has been output, the queued commands become the third command information, the fifth command information, and the seventh command information. Accordingly, the queue depth is increased by “1”, and becomes again “3” (see reference numeral 437).

According to the third command, the third DMA setup FIS 341, the third data FIS 342, and the third SDB FIS 343 are output. For example, the third command information is performed. Accordingly, the queue depth is decreased by “1”, and becomes “2” (see reference numeral 443).

Similarly, the interface 120 disregards the eighth H2D FIS 308 and receives the ninth H2D FIS 309 that includes the ninth command information during the delay period tD next to the third SDB FIS 343. Since the third data corresponding to the third command information has been output, the queued commands become the fifth command information, the seventh command information, and the ninth command information. Accordingly, the queue depth is increased by “1”, and becomes again “3” (see reference numeral 449).

As described above using FIG. 5, the semiconductor device (for example, slave device 100) according to an exemplary embodiment of the present invention may receive the FIS including the command through the delay period tD. Accordingly, the queue depth can be kept a constant level. For example, the queue depth fluctuation problem does not occur.

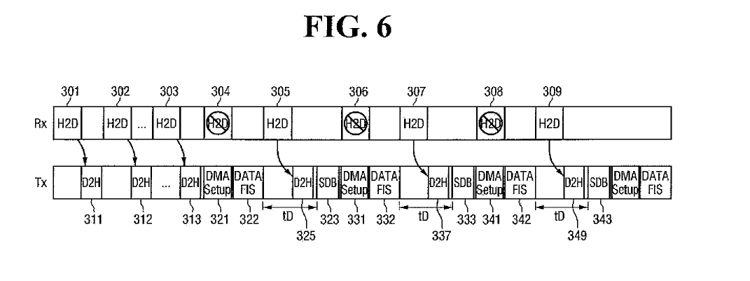

FIG. 6 is a timing diagram illustrating an operation of the interface illustrated in FIG. 2. For convenience in explanation, explanation will be made, giving the first consideration to portions that are different from those as described above using FIGS. 3 to 5 and it may be assumed that portions not described are at least similar to corresponding elements of prior figures.

Referring to FIG. 6, the interface 120 may insert an intentional delay period tD next to the data FIS. For example, the intentional delay period tD may be inserted next to the first data FIS 322 (for example, between the first data FIS 322 and the second SDB FIS 333) and next to the third data FIS 342 (for example, between the third data FIS 342 and the third SDB FIS 343).

If the intentional delay period tD is inserted into the data transfer period, the master device 200 can transfer the command (for example, H2D FIS including the command) to the slave device 100 during the inserted delay period tD.

For example, while the interface 120 outputs the first DMA setup FIS 321 and the first data FIS 322, the second DMA setup FIS 331 and the second data FIS 332, and the third DMA setup FIS 341 and the third data FIS 342, the H2D FIS 304, 306, and 308 that are sent by the master device 200 are disregarded. However, during the delay period tD, the interface 120 can receive the H2D FIS 305, 307, and 309. Accordingly, during the delay period tD, the interface 120 can output the D2H FIS 325, 337, and 349.

In FIGS. 4 to 6, it is exemplified that the delay period tD is inserted next to the data FIS or next to the SDB FIS. However, the insertion of the delay period tD is not limited thereto, but may be inserted next to the DMA setup FIS.

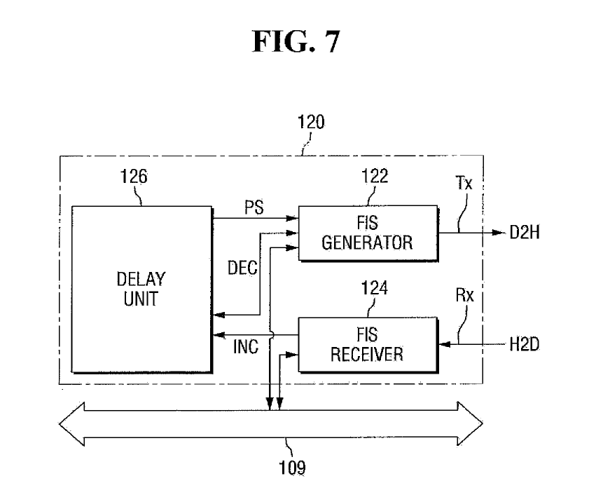

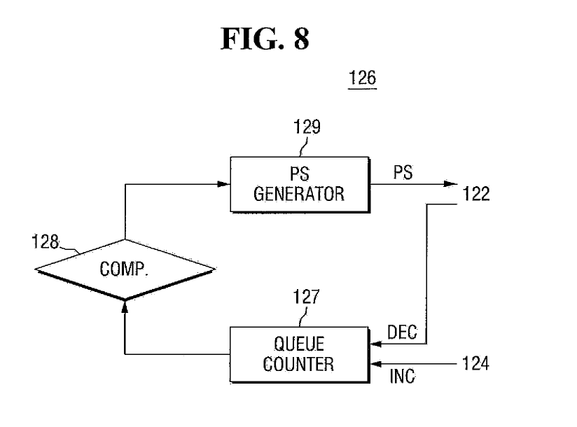

FIG. 7 is a block diagram illustrating the semiconductor device according to an exemplary embodiment of the present invention. FIG. 8 is a block diagram illustrating a delay unit illustrated in FIG. 7. For convenience in explanation, explanation will be made, giving the first consideration to portions that are different from those as described above using FIG. 3.

Referring to FIGS. 7 and 8, in the semiconductor device according to an exemplary embodiment of the present invention, the interface 120 may transfer multiple FIS while inserting a delay period between the multiple FIS. Here, the delay period may not always be fixed, but may be a dynamically changed period. For example, if the number of queued commands that have not been performed is sufficient, the delay period may be set to “0”. Further, if the number of queued commands is equal to or larger than the reference number, the delay period may be set to “0”. By contrast, if the number of queued commands is smaller than the reference number, the delay period may be inserted.

The interface 120 may include a delay unit 126, an FIS receiver 124, and an FIS generator 122. The delay unit 126 determines the delay value. Here, the delay value may be a value that is dynamically changed. For this operation, the delay unit 126 may include a counter 127, a comparator 128, and a prohibition signal generator 129.

Specifically, the FIS receiver 124 provides an increment signal INC to the delay unit 126 whenever the FIS including the command is input. The FIS generator 122 provides a decrement signal DEC to the delay unit 126 whenever the FIS including the data is output. The counter 127 may count the number of queued commands that have not been performed according to the increment signal INC and the decrement signal DEC. If the increment signal INC is input 10 times and the decrement signal DEC is input twice to the counter 127, the counter 127 can recognize that the number of queued commands is 8.

The comparator 128 compares the counted number of queued commands with the reference number.

The prohibition signal generator 129 determines the delay value according to the result of the comparison by the comparator 128, and generates a prohibition signal PS that corresponds to the delay value. The FIS generator 122 does not generate the FIS in a period where the prohibition signal PS is activated. For example, the period where the prohibition signal PS is activated corresponds to the above-described delay period tD.

On the other hand, the reference number may be determined using a time for preparing the output of data and a time for transferring the data. For example, if it is assumed that the time for preparing the output of data is 100 μs and the time for transferring the data is 10 μs, the reference number may be determined, for example, 10 (=100 μs/10 μs). For example, if the number of queued commands exceeds 10, the delay period tD may be inserted to receive a new command.

Further, the time for preparing the output of data may be determined, for example, using a time (see 351, 361, and 371 in FIG. 4) for reading data from the memory (see 160 in FIG. 2) and a time (see 352, 362, and 372 in FIG. 4) for loading the read data to the buffer (see 130 in FIG. 2). For example, the time for preparing the output of data may be a sum of the time for reading the data from the memory and the time for loading the read data to the buffer.

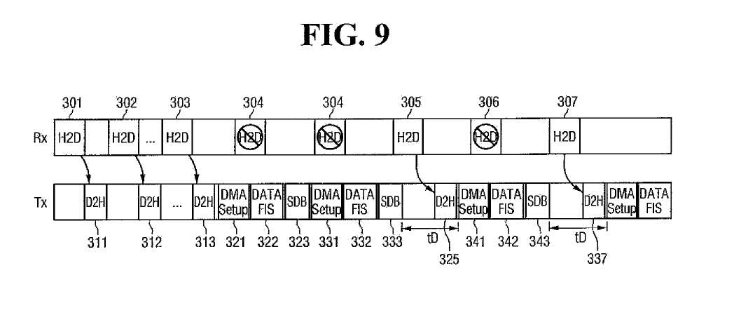

FIG. 9 is a timing diagram illustrating the operation of the interface illustrated in FIGS. 7 and 8.

Referring to FIG. 9, the interface 120 the interface 120 may transfer multiple FIS while inserting a delay period between the multiple FIS. Here, the delay period need not always be fixed, but may be a dynamically changed period. If the number of commands in the queuing state (queued commands) that have not been performed is sufficient, the delay period may be set to “0”. If the number of queued commands is small, the delay period may be inserted. As an example, the interface unit 120 may insert an intentional delay period tD next to the third H2D FIS 303.

The interface 120 successively receives the first H2D FIS 301, the second H2D FIS 302, and the third H2D FIS 303 through the receiving channel Rx.

Further, the interface 120 outputs the first D2H FIS 311 in response to the first H2D FIS 301, outputs the second D2H FIS 312 in response to the second H2D FIS 302, and outputs the third D2H FIS 313 in response to the third H2D FIS 303, through the transfer channel Tx.

According to the first command included in the first H2D FIS 301, the interface 120 outputs the first DMA setup FIS 321, the first data FIS 322, and the first SDB FIS 321 The first command information is performed. Here, since the number of queued commands is sufficient, the delay period is set to “0”. For example, the delay period is not inserted.

According to the second command included in the second H2D FIS 302, the interface 120 outputs the second DMA setup FIS 331, the second data FIS 332, and the second SDB FIS 333. The second command information is performed.

After the second command information is performed, the number of queued commands becomes smaller than the reference number. Accordingly, the interface 120 inserts the delay period tD after the second SDB FIS 333.

The interface 120 may receive the fifth H2D FIS 305 including the fifth command information during the delay period tD next to the second SDB FIS 333. As a result, the interface 120 outputs the fifth D2H FIS 325 in response to the fifth H2D FIS 305.

Then, according to the third command included in the third H2D FIS 303, the interface 120 outputs the third DMA setup FIS 341, the third data FIS 342, and the third SDB FIS 343. The third command information is performed.

After the third command information is performed, the number of queued commands becomes smaller than the reference number. Accordingly, the interface 120 inserts the delay period tD after the third SDB FIS 343.

The interface 120 receives the seventh H2D FIS 307 including the seventh command information during the delay period tD next to the second SDB FIS 343.

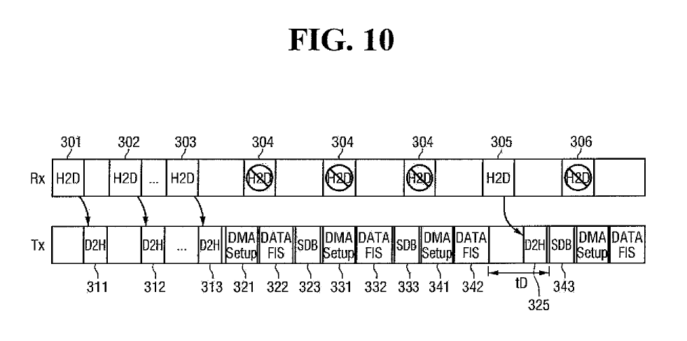

FIG. 10 is a timing diagram illustrating an operation of the interface illustrated in FIGS. 7 and 8. For convenience in explanation, explanation will be made, giving the first consideration to portions that are different from those as described above using FIG. 9.

Referring to FIG. 10, the interface 120 may insert an intentional delay period tD next to the data FIS.

While the interface 120 outputs the first DMA setup FIS 321, the first data FIS 322, the first SDB FIS 323, the second DMA setup FIS 331, the second data FIS 332, and the second SDB FIS 333, the H2D FIS 304 is disregarded. The first command information and the second command information are performed.

After the second command information is performed, the number of queued commands becomes smaller than the reference number. Accordingly, after the third data FIS 342 (for example, between the third data FIS 342 and the third SDB FIS 343), the interface 120 inserts the delay period ID.

The interface 120 may receive the fifth H2D FIS 305 including the fifth command information during the delay time tD next to the third data FIS 342. As a result, the interface 120 outputs the fifth D2H FIS 325 in response to the fifth H2D FIS 305. The fifth command information is queued.

In FIGS. 9 and 10, it is exemplified that the delay period tD is inserted next to the data FIS or next to the SDB FIS. However, insertion of the delay period tD is not limited thereto, but may be inserted next to the DMA setup FIS.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A semiconductor device comprising:
a delay unit determining a delay value;
a Frame Information Structure (FIS) receiver connected to a transfer channel and receiving a first Host to Device (H2D) FIS including first command information; and
a FIS generator connected to a receiving channel and successively outputting a first Direct Memory Access {DMA) setup FIS, a first data FIS, and a first Set Device Bits (SDB) FIS after outputting a first Device to Host (D2H) FIS in response to the first H2D FIS, and inserting a delay period, having the delay value, next to either the first data FIS or the first SDB FIS.

2. The semiconductor device of claim 1, wherein the FIS receiver sequentially receives a second H2D FIS including second command information and a third H2D FIS including third command information after receiving the first H2D FIS.

3. The semiconductor device of claim 2, wherein the FIS generator outputs a third D2H FIS in response to the third H2D FIS in the delay period between the first data FIS and the first H2D FIS.

4. The semiconductor device of claim 2, wherein the FIS generator outputs a third D2H FIS in response to the third H2D FIS in the delay period next to the first SDB FIS.

5. The semiconductor device of claim 1, wherein the semiconductor device performs communication using a serial Advanced Technology Attachment (ATA) protocol.

6. The semiconductor device of claim 5, wherein the semiconductor device uses an Advanced Host Controller Interface (AHCI) mode.

7. The semiconductor device of claim 1, wherein the delay value is a fixed value.

8. The semiconductor device of claim 1, wherein the FIS receiver successively receives the first H2D FIS including the first command information and second to n-th 112D FIS each including second to n-th command information, respectively, and wherein the delay unit adjusts the delay value according to a number of queued commands that have not been performed among the first to n-th command information.

9. The semiconductor device of claim 8, wherein when the number of queued commands is equal to or larger than a reference number, the delay unit sets the delay value to “0”.

10. The semiconductor device of claim 9, wherein the reference number is determined using time for preparing data output and time for data transfer.

11. The semiconductor device of claim 10, wherein the time for preparing the data output is determined using time for reading data from a memory and time for loading the read data to a buffer.

12. The semiconductor device of claim 8, wherein the delay unit comprises:
a counter counting the number of queued commands;
a comparator comparing the counted number of queued commands with a reference number; and
a prohibition signal generator determining the delay value according to the result of the comparison performed by the comparator and generating a prohibition signal corresponding to the delay value.

13. The semiconductor device of claim 1, wherein the semiconductor device is a Solid Static Disk (SSD).

14. A semiconductor device comprising:
a Frame Information Structure (FIS) receiver successively receiving first to n-th (where, n is a natural number that is equal to or larger than 2) Host to Device (H2D) FIS that include first to n-th command information, respectively; and
a FIS generator successively outputting first to m-th (where, m is a natural number that is equal to or larger than 2) FIS related to the first to n-th command information after successively outputting first to n-th D2H FIS in response to the first to n-th H2D FIS,
wherein while the FIS generator outputs only parts of the first to m-th FIS, the FIS receiver receives the (n+1)-th H2D FIS, and
the FIS generator outputs the (n+1)-th D2H FIS in response the (n+1)-th H2D FIS, between a k-th (where, k is a natural number that satisfies 1<k<m) FIS and a (k+1)-th FIS.

15. The semiconductor device of claim 14, wherein m is equal to 3 n.

16. A method for conducting Serial Advanced Technology Attachment (SATA) communication, comprising:
determining a delay value;
receiving a first Host to Device (H2D) Frame Information Structure (FIS) including first command information; and
successively outputting a first Direct Memory Access (DMA) setup FIS, a first data FIS, and a first Set Device Bits (SDB) FIS after outputting a first Device to Host (D2H) FIS in response to the first H2D FIS, and inserting a delay period, having the delay value, next to either the first data FIS or the first SDB FIS.

17. The method of claim 16, wherein a second H2D FIS including second command information and a third H2D FIS including third command information are sequentially received after receiving the first H2D FIS and a third D2H FIS is output in response to the third H2D FIS in the delay period between the first data FIS and the first H2D FIS.

18. The method of claim 16, wherein an Advanced Host Controller Interface (AHCI) mode is used.

19. The method of claim 16, wherein the delay value is a fixed value.

20. The method of claim 16, wherein the first H2D FIS including the first command information and second to n-th H2D FIS each including second to n-th command information, respectively, are successively received, the delay value is adjusted according to a number of queued commands that have not been performed among the first to n-th command information, when the number of queued commands is equal to or larger than a reference number, the delay value is set to “0”, the reference number is determined using time for preparing data output and time for data transfer, and the time for preparing the data output is determined using time for reading data from a memory and time for loading the read data to a buffer.
